(19) United States
(12) Patent Application Publication
(10) Pub. No.: US 2024/0426628 A1
(43) Pub. Date: Dec. 26, 2024

(54) APPARATUS AND METHOD OF DETECTING PARKING POSITION OF VEHICLE

(71) Applicants: Hyundai Motor Company, Seoul (KR); Kia Corporation, Seoul (KR)

(72) Inventors: Young Gul Cho, Seoul (KR); Jaho Koo, Seoul (KR); Tae Young Heo, Yongin (KR); Seung Eun Kim, Seoul (KR)

(21) Appl. No.: 18/381,399

(22) Filed: Oct. 18, 2023

(30) Foreign Application Priority Data
Jun. 21, 2023 (KR) 10-2023-0079881

(51) Int. Cl. G01C 21/36; G01C 21/28

(52) U.S. Cl. CPC G01C 21/3685; G01C 21/28

(57) ABSTRACT

An apparatus for detecting a parking position of a vehicle includes a first driving route module for generating a first driving route of a vehicle based on driving information including a speed and a direction of the vehicle through an indoor parking lot; a second driving route module for generating a second driving route by inputting the generated first driving route into an artificial intelligence model; and a parking position determining module for determining a final parking position of the vehicle in the indoor parking lot based on the generated second driving route.

### CROSS-REFERENCE TO RELATED APPLICATION

This application claims under 35 U.S.C. § 119 (a) the benefit of Korean Patent Application No. 10-2023-0079881 filed in the Korean Intellectual Property Office on Jun. 21, 2023, the entire contents of which are incorporated herein by reference.

### BACKGROUND

### (a) Technical Field

The present disclosure relates to an apparatus and method of detecting a parking position of a vehicle, more particularly, to the apparatus and method that are configured to detect a driving route and a final parking position of a vehicle within an indoor parking lot by using only driving information obtained from the vehicle without Global Positioning System (GPS) information.

### (b) Description of the Related Art

A connected vehicle is one that can connect to the internet, and also which is capable of making voice calls, finding maps, and providing vehicle occupants with news, weather, and real-time traffic information. Through a display on the dashboard, various functions, such as music play, navigation, smart phone application execution, and driving assistance, may be typically executed.

The connected vehicle may communicate with surrounding objects (for example, neighboring vehicles, infrastructure systems, smartphones, and wireless devices) based on wireless communication (V2V (Vehicle-to-Vehicle), V2I (Vehicle-to-Infrastructure)), centered on the vehicle, and is networked and connected to the Internet of Things. The main characteristics of the connected vehicle include identifying traffic flow and accident situations through communication with surrounding vehicles and information technology-based systems, providing integrated infotainment services through connection with external devices, such as smartphones, and controlling vehicles in operation based on information provided by surrounding vehicles or the central control center.

When a connected vehicle is used, it is possible to detect the vehicle's driving route and parking position indoors or underground that is a communication-shaded area without GPS information by utilizing driving data, such as vehicle speed and driving direction (steering wheel angle). In this case, there is a problem in that the longer the vehicle travels, the larger the error in determining the driving route and parking position.

### SUMMARY

The present disclosure provides an apparatus and method of detecting a parking position of a vehicle, which corrects an error generated in a driving route formed with speed/driving direction data collected from a vehicle through dead reckoning by using virtual data and machine learning, in order to accurately detect a driving route and a final parking position of the vehicle.

An exemplary embodiment provides an apparatus for detecting a parking position of a vehicle, the apparatus including: a first driving route module for generating a first driving route of a vehicle through dead reckoning based on driving information including a speed and a direction of the vehicle collected from the user's vehicle driving through an indoor parking lot; a second driving route module for inputting the generated first driving route into an artificial intelligence model that corrects errors between the virtual driving route of the vehicle and an actual driving route of the indoor parking lot through machine learning to generate a second driving route; and a parking position determining module for determining a final parking position of said vehicle in said indoor parking lot based on the generated second driving route.

The first driving route module may be formed of a plurality of unit vectors generated based on the driving information of the vehicle.

The second driving route module may sequentially correct an error in each of said plurality of unit vectors configuring said first driving route in a chronological order through the artificial intelligence model.

The apparatus may further include an artificial intelligence model module for generating the artificial intelligence model, in which the artificial intelligence model module may include: an actual driving route data receiving module for receiving a plurality of actual driving route data collected from vehicles driving through an indoor parking lot; a reference driving route data module for generating reference driving route data in which the driving route of the indoor parking lot is formed as a vector space in a shape of a polygon; a virtual driving route data module for generating a plurality of virtual driving route data for each of the actual driving route data by reflecting characteristics of the actual driving route data in the reference driving route data; and a machine learning module for performing machine learning to compare the actual driving route data and the virtual driving route data with the reference driving route data, and to extract and correct an error.

The actual driving route data and the virtual driving route data may include a unit vector reflecting a driving speed and direction of the vehicle.

The vector space in the shape of a polygon configuring the reference driving route data may include a straight section and a corner section, and the virtual driving route data module may generate the plurality of virtual driving route data by reflecting a characteristic of the unit vector configuring the actual driving route data in the corner section.

The virtual driving route data module may generate the plurality of virtual driving route data by reflecting a characteristic of the unit vector configuring the actual driving route data in the straight section.

At least some of the plurality of generated virtual driving route data may have a rounded shape in the corner section and a meandering shape in the straight section.

The second driving route module may generate the second driving route in a grid form.

The parking position determining module may sequentially connect the second driving route to a driving route according to the driving information including a speed and a direction of the vehicle at the time of arrival at the indoor parking lot to determine the final parking position of the vehicle.

Another exemplary embodiment provides a method of detecting a parking position of a vehicle, the method including: generating, by a first driving route module, a first driving route of a vehicle through dead reckoning based on driving information including a speed and a direction of the vehicle collected from the user's vehicle driving through an indoor parking lot; generating, by a second driving route module, a second driving route by inputting the generated first driving route to an artificial intelligence model that corrects errors between the virtual driving route of the vehicle and an actual driving route of the indoor parking lot through machine learning; and determining, by a parking position determining module, a final parking position of the vehicle in the indoor parking lot based on the generated second driving route.

The generating of the first driving route may include generating the first driving route formed of a plurality of unit vectors that represents the driving information of the vehicle, respectively.

The generating of the second driving route may include sequentially correcting an error in each of the plurality of unit vectors configuring the first driving route in a chronological order through the artificial intelligence model.

The method may further include generating the artificial intelligence model, in which the generating of the artificial intelligence model may include: receiving, by an actual driving route data receiving module, a plurality of actual driving route data collected from vehicles driving through an indoor parking lot; generating, by a reference driving route data module, reference driving route data in which the driving route of the indoor parking lot is formed as a vector space in the shape of a polygon; generating, by a virtual driving route data module, a plurality of virtual driving route data for each of the actual driving route data by reflecting characteristics of the actual driving route data in the reference driving route data; and performing, by a machine learning module, machine learning to compare the actual driving route data and the virtual driving route data with the reference driving route data, and to extract and correct an error.

The actual driving route data and the virtual driving route data may be formed of a unit vector reflecting a driving speed and direction of the vehicle.

The vector space in the shape of a polygon configuring the reference driving route data may include a straight section and a corner section, and the generating of the virtual driving route data may include generating the plurality of virtual driving route data by reflecting a characteristic of the unit vector configuring the actual driving route data in the corner section.

The generating of the virtual driving route data may further include generating the plurality of virtual driving route data by reflecting a characteristic of the unit vector configuring the actual driving route data in the straight section.

At least some of the plurality of generated virtual driving route data may have a rounded shape in the corner section and a meandering shape in the straight section.

The generating of the second driving route may include generating the second driving route in a grid form.

The determining of the final parking position of the vehicle may include sequentially connecting the second driving route to a driving route according to the driving information including a speed and a direction of the vehicle at the time of arrival at the indoor parking lot to determine the final parking position of the vehicle.

The apparatus and the method of detecting the parking position of the vehicle according to the exemplary embodiments may more accurately estimate the driving route and a final parking position of the vehicle in indoors or underground by using connected car data stored in the vehicle, to determine the parking position of the vehicle parked in a building and provide the determined parking position to a customer.

The apparatus and the method of detecting the parking position of the vehicle according to the exemplary embodiments do not require installation of additional equipment, and the like and are minimized with customization for an individual parking lot, making it easy to expand application targets and highly versatile.

### BRIEF DESCRIPTION OF THE DRAWINGS

FIG. 1 is a block diagram of a vehicle parking position detection system according to an exemplary embodiment.

FIG. 2 is a block diagram of a vehicle parking position detection apparatus of FIG. 1 according to the exemplary embodiment.

FIG. 3 is a block diagram of an artificial intelligence model generating unit of FIG. 2 according to the exemplary embodiment.

FIG. 4 is a flowchart of a vehicle parking position detection method according to an exemplary embodiment.

FIG. 5 is a flowchart illustrating a method of generating an artificial intelligence model by using the vehicle parking position detection method according to the exemplary embodiment.

FIG. 6 is a diagram illustrating an exemplary embodiment of generating virtual driving route data through the vehicle parking position detection method according to the exemplary embodiment.

FIG. 7 is a diagram illustrating an exemplary embodiment of generating virtual driving route data through the vehicle parking position detection method according to the exemplary embodiment.

FIG. 8 is a diagram illustrating a driving route detected by the parking position detection apparatus according to the exemplary embodiment of the present disclosure.

FIG. 9 is a diagram illustrating a computing device according to an exemplary embodiment of the present disclosure.

### DETAILED DESCRIPTION OF THE EXEMPLARY EMBODIMENTS

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMS, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

The present disclosure will be described more fully hereinafter with reference to the accompanying drawings, in which exemplary embodiments of the disclosure are illustrated. As those skilled in the art would realize, the described exemplary embodiments may be modified in various different ways, all without departing from the spirit or scope of the present disclosure. Accordingly, the drawings and description are to be regarded as illustrative in nature and not restrictive. Like reference numerals designate like elements throughout the specification.

Terms including an ordinary number, such as first and second, are used for describing various constituent elements, but the constituent elements are not limited by the terms. The terms are used only to discriminate one constituent element from another constituent element.

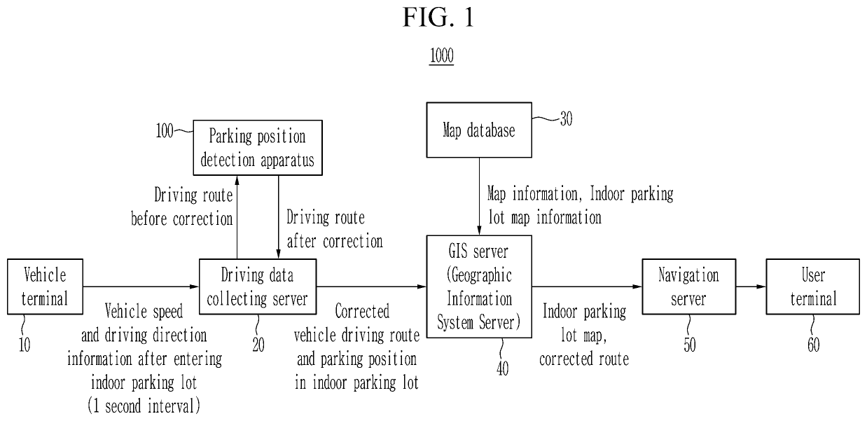

FIG. 1 is a block diagram of a vehicle parking position detection system according to an exemplary embodiment. Through an artificial intelligence model generated through machine learning and neural network training, a vehicle parking position detection system may detect and provide more accurate information about a driving route and a parking position of a vehicle within a parking lot. The vehicle parking position detection system may conveniently provide a user using the vehicle with information about an accurate driving route and parking position of the vehicle detected by using artificial intelligence based on connected car data of the vehicle through a vehicle terminal and a user terminal, even without an external infrastructure.

In the exemplary embodiment, the vehicle parking position detection system may automatically generate a map of an indoor parking lot with cumulative data including an indoor driving route and a final parking position collected from the connected car vehicle and the parking zone name (for example, K3 zone) directly entered by the user (or customer).

Referring to FIG. 1, a vehicle parking position detection system 1000 includes a vehicle terminal 10, a driving data collection server 20, a map database 30, a Geographic Information System (GIS) server 40, a navigation server 50, a user terminal 60, and a parking position detection apparatus 100.

The vehicle terminal 10 may include a communication terminal, such as a telematics terminal of a vehicle. The vehicle terminal 10 may collect the driving data of the vehicle after the driving ends and transmit the collected driving data to the driving data collection server 20. For example, the vehicle terminal 10 may extract information about a speed and a direction of the vehicle after the time of entry into the indoor parking lot at one-second intervals and provide the driving data collection server 20 with the extracted information.

The driving data collection server 20 may collect driving data including driving information such as speed and direction of the vehicle provided by the vehicle or vehicle terminal 10. The driving data collection server 20 may estimate a driving route based on the driving information through dead reckoning. Dead reckoning may mean sailing or driving from an already known starting position and estimating a position of a vehicle or ship by calculating a course or route and speed. For example, a connected car may collect driving information about the vehicle's speed and direction that is provided to the user through a network connection indoors, such as underground, where there is no Global Positioning System (GPS) connection, and determine the route and position of the travelling vehicle through dead reckoning. The driving data collection server 20 may collect driving information of a vehicle driving through an indoor or underground parking lot and generate an initial driving route based on the collected driving information.

The driving data collection server 20 may provide the collected driving information and the initial driving route generated based on the driving information to the parking position detection apparatus 100. The driving data collection server 20 may receive information about a final driving route and a final parking position of the vehicle in the parking lot generated according to an error correction based on the initial driving route through the parking position detection apparatus 100. The driving data collection server 20 may provide the GIS server 40 with information about the final driving route and the final parking position.

The map database 30 includes map information about the parking lot. That is, the map database 30 may provide the vehicle with map information about the parking lot in which the vehicle is driving.

The GIS server 40 may extract map information of the parking lot in which the vehicle is driving from the map information received from the map database 30. The GIS server 40 may receive the final driving route and the final parking position of the vehicle from the driving data collection server 20. The GIS server 40 may map the final driving routes and the final parking position of the vehicle in the parking lot onto the extracted map of the parking lot.

The navigation server 50 may perform processing to provide customers with the final driving route and the final parking position mapped to the map of the parking lot. The navigation server 50 may include information provided in an application or on the web that is provided to the user through a user terminal 60.

The user terminal 60 may be provided as a user's mobile phone, tablet PC, or the like, which provides the user with information provided by the navigation server 50 via an application or the web. The user terminal 60 may correspond to various forms of terminal devices capable of displaying maps, driving routes, and parking positions to a user via a display.

The parking position detection apparatus 100 may correct errors included in the estimated driving route and parking position through an artificial intelligence model, and finally detect an accurate driving route and parking position of the vehicle by using the driving information, such as vehicle speed and vehicle driving direction, collected from a vehicle driving through an indoor/underground parking lot.

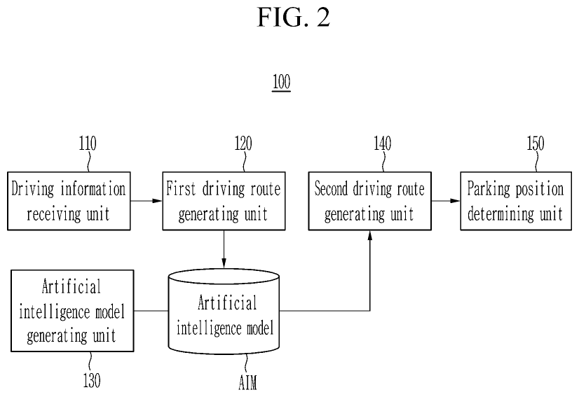

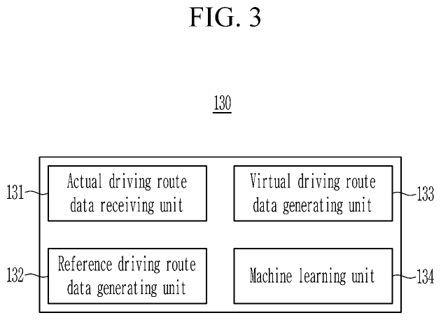

When an indoor driving route is predicted by dead reckoning by using driving data, such as vehicle speed and driving direction (steering wheel angle), without GPS information in underground that is a communication-shaded area, errors accumulate in the data collected from the vehicle, and the longer the vehicle drives, the more the driving route differs from the actual driving route, and the parking position detection apparatus 100 may more accurately estimate the actual route of the vehicle and the final parking position by using the vehicle driving data (speed/direction) and virtual data generated after entering the indoor parking lot, and the error correction methods through the neural network machine learning. A more detailed description of the parking position detection apparatus 100 is given with reference to FIGS. 2 and 3.

FIG. 2 is a block diagram of the vehicle parking position detection apparatus of FIG. 1 according to the exemplary embodiment.

Referring to FIG. 2, the parking position detection apparatus 100 may be a controller that includes a driving information receiving unit (or module) 110, a first driving route generating unit (or module) 120, an artificial intelligence model generating unit (or module) 130, an artificial intelligence model AIM, a second driving route generating unit (or module) 140, and a parking position determining unit (or module) 150.

Each of the above units may constitute modules and/or devices of the parking position detection apparatus 100, which may be a controller. For example, the above units of the parking position detection apparatus 100 may constitute hardware components that form part of a controller (e.g., modules or devices of a high-level controller), or may constitute individual controllers each having a processor and memory. The parking position detection apparatus 100 may include one or more processors and memory.

The driving information receiving unit 110 may receive driving information about a speed and a direction of the vehicle from the driving data collection server 20 (see FIG. 1) and/or information about an initial driving route generated by dead reckoning based on the driving information.

The first driving route generating unit 120 may generate a first driving route based on the driving information and the initial driving route of the vehicle from the driving information receiving unit 110. The first driving route generating unit 120 may generate a first driving route of the vehicle through dead reckoning based on the driving information including the speed and the direction of the vehicle collected from the user's vehicle driving the indoor parking lot.

In another exemplary embodiment, the first driving route generating unit 120 may receive the initial driving route generated through dead reckoning from the driving data collection server 20. In this case, the first driving route generating unit 120 may process the received initial driving route to generate the first driving route.

In the exemplary embodiment, the first driving route generating unit 120 may be formed of a plurality of unit vectors. The first driving route generating unit 120 may include a plurality of unit vectors, each of which includes information about a speed and a direction of the traveling vehicle at a particular time point. Each of the plurality of unit vectors may be extracted based on the difference in speed and direction included in the driving information at adjacent time points. For example, the difference value in the vector of the speed and the direction included in each driving information collected at each of consecutive x and y seconds may cpmfogire a unit vector.

The first driving route generating unit 120 may generate a unit vector from a plurality of chronologically adjacent vectors. For example, the first driving route generating unit 120 may group four vectors adjacent in chronological order in seconds to form a unit vector.

The first driving route generating unit 120 may provide the artificial intelligence model AIM with the first driving route formed of the generated unit vectors. The artificial intelligence model AIM performs an error correction operation of generating a second driving route based on the first driving route formed of the received unit vectors. In another exemplary embodiment, the artificial intelligence model AIM may configure the initial driving route estimated through dead reckoning in the unit of the unit vector. The first driving route generating unit 120 may configure the initial driving route with the plurality of unit vectors through the artificial intelligence model AIM.

The artificial intelligence model generating unit 130 may generate an artificial intelligence model AIM that corrects the error between the driving route of the vehicle and the actual driving route in the indoor parking lot through machine learning.

In the exemplary embodiment, the artificial intelligence model generating unit 130 may receive actual driving route data collected by a real vehicle driving thoroughly the indoor parking lot. Based on the map, the artificial intelligence model generating unit 130 may construct the driving route in the indoor parking lot as a polygon and define the polygonal driving route as a reference driving route. The artificial intelligence model generating unit 130 may generate a plurality of virtual driving route data similar to the actual driving route data by reflecting the characteristics and noise of the actual driving route data in the reference driving route. The artificial intelligence model generating unit 130 may generate an artificial intelligence model that compares the virtual driving route data and the reference driving route data through machine learning to correct errors in the virtual driving route data. This will be described in more detail with reference to FIG. 3.

The second driving route generating unit 140 may generate a second driving route by inputting the first driving route into the artificial intelligence model AIM. The second driving route may be a driving route obtaining by correcting an error generated when the first driving route estimated by dead reckoning is compared to the actual driving route. That is, the second driving route may be error-corrected to provide the same level of information as the vehicle's actual driving route in the indoor parking lot.

The second driving route generating unit 140 may perform an error correction operation to generate the second driving route based on the first driving route formed of a unit vector through the artificial intelligence model AIM. In one exemplary embodiment, the second driving route generating unit 140 may sequentially correct errors in each of the plurality of unit vectors forming the first driving route in a chronological order by using the artificial intelligence model AIM. For example, the second driving route generating unit 140 may sequentially perform error correction by inputting a plurality of unit vectors, each consisting of four adjacent vectors, into the artificial intelligence model AIM in chronological order.

The second driving route generating unit 140 may generate the second driving route in the form of a grid. In other words, the second driving route generating unit 140 may implement the second driving route in a grid form that corresponds to the grid form of the driving route in the actual indoor parking lot.

The parking position determining unit 150 may determine a final parking position of the vehicle in the indoor parking lot based on the second driving route. The parking position determining unit 150 may specify the final parking position of the vehicle by sequentially connecting the corrected vectors included in the second driving route to the initial driving route at the time of first reaching each floor of the indoor parking lot.

FIG. 3 is a block diagram of the artificial intelligence model generating unit of FIG. 2 according to the exemplary embodiment.

Referring to FIG. 3, the artificial intelligence model generating unit 130 may include an actual driving route data receiving unit 131, a reference driving route data generating unit 132, a virtual driving route data generating unit 133, and a machine learning unit 134.

The actual driving route data receiving unit 131 may receive a plurality of actual driving route data collected from vehicles driving through the indoor parking lot.

The reference driving route data generating unit 132 may generate reference driving route data in which a driving route in the indoor parking lot is configured with a vector space in the shape of a polygon. The reference driving route data generating unit 132 may extract a driving route through a map of the indoor parking lot and configure the extracted driving route into a vector space in the shape of a polygon. The vector space in the shape of a polygon configuring the reference driving route data may include straight sections and corner sections.

The virtual driving route data generating unit 133 may generate a plurality of virtual driving route data for each of the actual driving route data by reflecting the characteristics of the actual driving route data in the reference driving route data. The actual driving route data may include characteristics that the route is round in the corner section, the route is meandering in the straight section, or the entire route is bent.

In one exemplary embodiment, the actual driving route data and the virtual driving route data may include a unit vector reflecting a driving speed and a direction of the vehicle. The vector space in the shape of a polygon configuring the reference driving route data may include straight sections and corner sections.

The virtual driving route data generating unit 133 may generate a plurality of virtual driving route data by reflecting the characteristic that the unit vectors configuring the actual driving route data are arranged in a round shape in the corner section. Furthermore, the virtual driving route data generating unit 133 may generate a plurality of virtual driving route data reflecting the characteristic that the unit vectors configuring the actual driving route data are arranged in a meandering shape in the straight section. Thus, at least some of the plurality of generated virtual driving route data may have a rounded shape in the corner section and a meandering shape in the straight section.

The machine learning unit 134 may perform machine learning to generate an artificial intelligence model (or neural network model) that compares the virtual driving route data and the actual driving route data having the same characteristics with the reference driving route data, and extracts and corrects errors. The machine learning unit 134 may perform machine learning to compare the reference driving route data with tens of thousands of virtual driving route data generated from the actual driving route data. For example, the machine learning unit 134 may perform machine learning for error correction to generate a final driving route in the form of a grid based on the virtual driving route data including the corner section in the round shape and the straight section in the meandering shape.

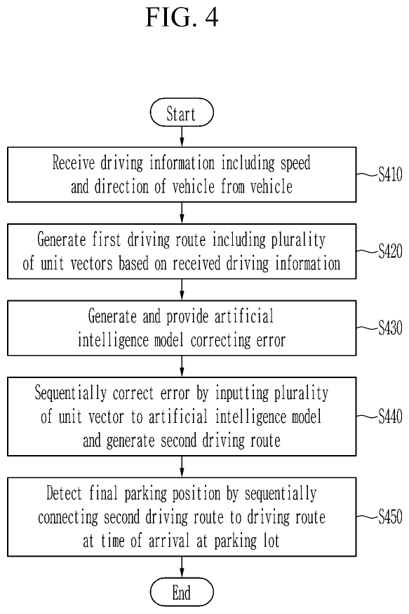

FIG. 4 is a flowchart of a vehicle parking position detection method according to an exemplary embodiment.

In FIG. 4, the vehicle parking position detection apparatus 100 (see FIG. 1) may generate a machine learning-based artificial intelligence model to correct an error between a vehicle's driving route and an actual driving route in an indoor parking lot through the artificial intelligence model generating unit and provide the generated artificial intelligence model (operation S430).

The vehicle parking position detection apparatus 100 may receive driving information including a vehicle's speed and direction collected from a user's vehicle driving through the indoor parking lot (operation S410).

The vehicle parking position detection apparatus 100 may estimate and generate a first driving route based on the vehicle's driving information. The vehicle parking position detection apparatus 100 may estimate the vehicle's driving route through dead reckoning and generate a first driving route including a plurality of unit vectors, each including vectors in the unit of second (operation S420).

The vehicle parking position detection apparatus 100 may input the first driving route into an artificial intelligence model to generate a second driving route. The vehicle parking position detection apparatus 100 may sequentially input the plurality of unit vectors into an artificial intelligence model AIM (see FIG. 2) to correct errors and generate a second driving route (operation S440). The vehicle parking position detection apparatus 100 may perform sequential correction of the error of each of the plurality of unit vectors configuring the first driving route in a chronological order through the artificial intelligence model.

The vehicle parking position detection apparatus 100 may determine a final parking position of the vehicle in the indoor parking lot based on the second driving route. The vehicle parking position detection apparatus 100 may detect the final parking position by sequentially connecting the second driving route to the position or driving route of the vehicle at the time of reaching the parking lot (operation S450).

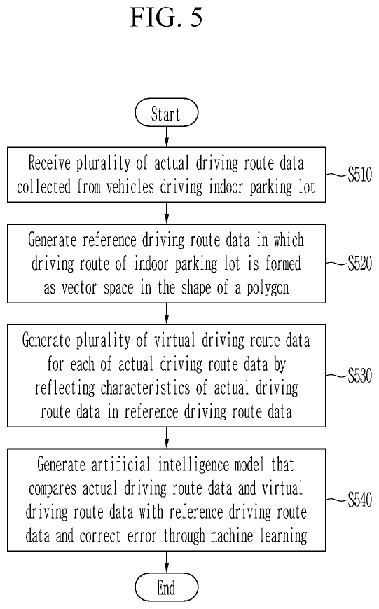

FIG. 5 is a flowchart illustrating a method of generating an artificial intelligence model by using the vehicle parking position detection method according to the exemplary embodiment.

In FIG. 5, the artificial intelligence model generation portion 130 (see FIG. 2) may receive a plurality of actual driving route data collected from vehicles driving through the indoor parking lot (step S510).

The artificial intelligence model generating unit 130 may generate reference driving route data in which the driving route of the indoor parking lot is formed as a polygonal vector space (operation S520).

The artificial intelligence model generating unit 130 may generate a plurality of virtual driving route data for each of the actual driving route data by reflecting the characteristic of the actual driving route data in the reference driving route data (operation S530).

The artificial intelligence model generating unit 130 may generate an artificial intelligence model that corrects errors through machine learning, which compares the actual driving route data and the virtual driving route data similar to the actual driving route data with the reference driving route data (operation S540). The artificial intelligence model generating unit 130 may generate an artificial intelligence model or a neural network model that corrects errors in the actual driving route data and the virtual driving route data similar to the actual driving route data based on the reference driving route data through machine learning.

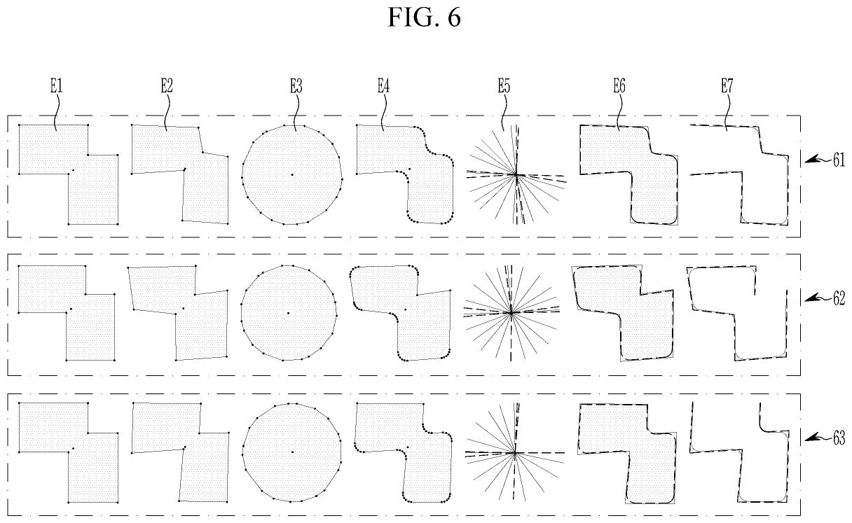

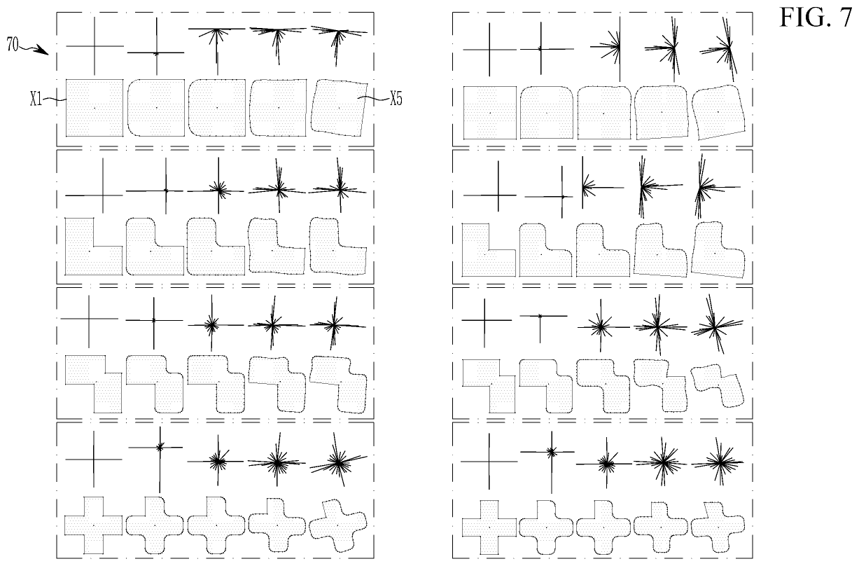

FIG. 6 is a diagram illustrating an exemplary embodiment of generating virtual driving route data through the vehicle parking position detection method according to the exemplary embodiment. FIG. 7 is a diagram illustrating an exemplary embodiment of generating virtual driving route data through the vehicle parking position detection method according to the exemplary embodiment.

FIG. 6 illustrates a first exemplary embodiment 61, a second exemplary embodiment 62, and a third exemplary embodiment 63 of generating virtual driving route data. Each of the first exemplary embodiment 61, the second exemplary embodiment 62, and the third exemplary embodiment 63 generates a different form of virtual driving route data from the same reference reference driving route data. The description of the first exemplary embodiment 61 replaces the description of the second exemplary embodiment 62 and the third exemplary embodiment 63.

In the first exemplary embodiment 61, the reference driving route data is provided in a reference form E1 including a vector space in the shape of a polygon. The reference form E1 is transformed into a second form E2 in which the noise of a straight section of actual driving is reflected. The second form reflects the motion characteristics of a vehicle that is not driving straight in a straight section. The second form E2 may be transformed into a third form E4 by reflecting a corner characteristic E3. The corner characteristic E3 may represent a vector that reflects the characteristics expressed by the vehicle's rounded movement in the corner section in actual driving. The third form E4 represents the form in which the corner characteristic E3 is reflected in the corner section of the second form E2. A directional map E5 represents the direction in which the vehicle is moving. The dotted line represents the direction of the vehicle's movement in the straight section, and the solid line represents the direction of the vehicle's movement in the corner section. A fourth form E6 represents a final form, in which the characteristics of the straight section and the corner section are reflected in the polygonal vector space in the reference form E1. The final route E7 shows the final driving route of the vehicle in the vector space of the fourth form E6 by a solid line.

FIG. 7 illustrates various exemplary embodiments 70 of generating virtual driving route data. A total of eight exemplary embodiments are illustrated, but will be described with reference to one exemplary embodiment.

In FIG. 7, a polygon X1 representing the reference driving route data is transformed into a final form X5 representing the virtual driving route data by reflecting the actual driving route data. The polygon X1 representing the reference driving route data is transformed from the reference form to the final form X5 by sequentially going through corner section transformation, straight section transformation, local transformation, and overall transformation. The final form X5 shows the rounded shape of the corner section and the meandering shape of the straight section in the vector space. Other exemplary embodiments show that the virtual driving route data is generated by the same method, except for different shapes, such as memory shapes and silver shapes.

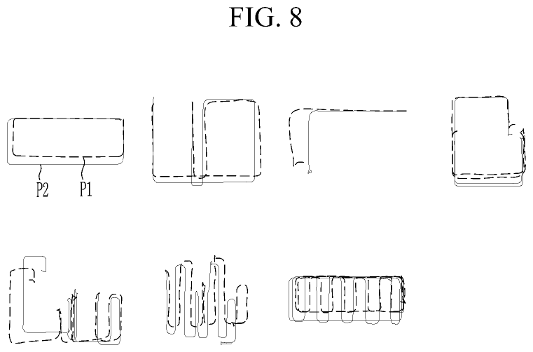

FIG. 8 is a diagram illustrating a driving route detected by the parking position detection apparatus according to the exemplary embodiment of the present disclosure.

In FIG. 8, the first route P1 in the dotted line shows the first driving route before the error is corrected. The second route P2 in the solid line shows the second driving route in which the error has been corrected. Compared to the first driving route, the second driving route shows a grid form. The first route P1 differs from the driving route in the grid form of the actual indoor parking lot, in which the corner section is rounded and the straight section is not straight. On the other hand, the second route P2 is represented in the shape in which the straight section is straight and the corner section is angular. That is, the second route P2 is represented in the form in which the error is corrected to match the map of the actual indoor parking lot.

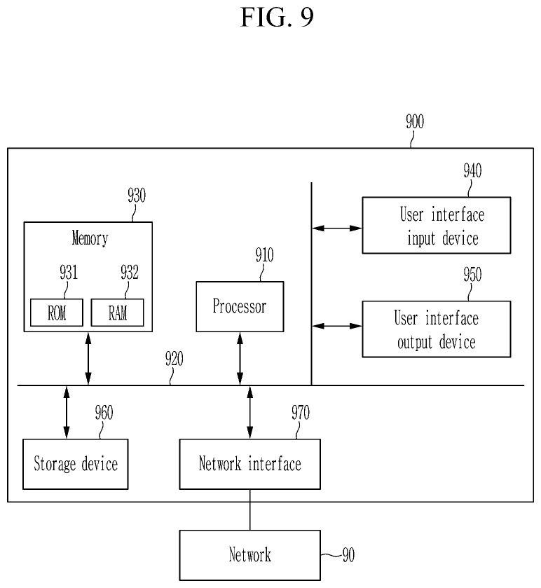

FIG. 9 is a diagram illustrating a computing device according to an exemplary embodiment of the present disclosure.

Referring now to FIG. 9, the vehicle parking position detection apparatus and method according to the exemplary embodiments may be implemented by using a computing device 900.

The computing device 900 may include at least one of a processor 910, a memory 930, a user interface input device 940, a user interface output device 950, and a storage device 960 communicating through a bus 920. The computing device 900 may also include a network interface 970 that is electrically connected to a network 90. The network interface 970 may transmit or receive a signal with another entity through the network 90.

The processor 910 may be implemented in various types, such as a Micro Controller Unit (MCU), an Application Processor (AP), a Central Processing Unit (CPU), a Graphic Processing Unit (GPU), a Neural Processing Unit (NPU), and the like, and may be a predetermined semiconductor device executing commands stored in the memory 930 or the storage device 960. The processor 910 may be configured to implement the function and the method described above with reference to FIGS. 1 to 9.

The memory 930 and the storage device 960 may include various types of volatile or non-volatile storage media. For example, the memory may include a Read Only Memory (ROM) 931 and a Random Access Memory (RAM) 932. In the exemplary embodiment, the memory 930 may be located inside or outside the processor 910, and the memory 930 may be connected with the processor 910 through already known various means.

In some exemplary embodiments, at least some configurations or functions of the vehicle parking position detection apparatus and method according to the exemplary embodiments may be implemented as programs or software executed on the computing device 900, and the programs or software may be stored on a computer-readable medium.

In some exemplary embodiments, at least some configurations or features of the vehicle parking position detection apparatus and method according to the exemplary embodiments may be implemented using hardware or circuit of the computing device 900, or may be implemented as separate hardware or circuit that may be electrically connected to computing device 900.

Although the above exemplary embodiments of the present disclosure have been described in detail, the scope of the present disclosure is not limited thereto, but also includes various modifications and improvements by one of ordinary skill in the art utilizing the basic concepts of the present disclosure as defined in the following claims.

What is claimed is:

1. An apparatus for detecting a parking position of a vehicle, the apparatus comprising:
a first driving route module for generating a first driving route of the vehicle based on driving information including a speed and a direction of the vehicle through an indoor parking lot;
a second driving route module for inputting the generated first driving route into an artificial intelligence model that corrects errors between the first driving route of the vehicle and an actual driving route of the indoor parking lot through machine learning to generate a second driving route; and
a parking position module for determining a final parking position of the vehicle in the indoor parking lot based on the generated second driving route.

2. The apparatus of claim 1, wherein:
the first driving route module configures the first driving route with a plurality of unit vectors.

3. The apparatus of claim 2, wherein:
the second driving route module sequentially corrects an error in each of the plurality of unit vectors configuring the first driving route in a chronological order through the artificial intelligence model.

4. The apparatus of claim 1, further comprising:
an artificial intelligence model module for generating the artificial intelligence model,
wherein the artificial intelligence model module includes:
an actual driving route data receiving module for receiving a plurality of actual driving route data collected from vehicles driving through an indoor parking lot;
a reference driving route data module for generating reference driving route data in which the driving route of the indoor parking lot is formed as a vector space in a shape of a polygon;
a virtual driving route data module for generating a plurality of virtual driving route data for each of the actual driving route data by reflecting characteristics of the actual driving route data in the reference driving route data; and
a machine learning module for performing machine learning to compare the actual driving route data and the virtual driving route data with the reference driving route data, and to extract and correct an error.

5. The apparatus of claim 4, wherein:
the actual driving route data and the virtual driving route data include a unit vector reflecting a driving speed and direction of the vehicle.

6. The apparatus of claim 5, wherein:
the vector space in the shape of a polygon configuring the reference driving route data includes a straight section and a corner section, and
the virtual driving route data module generates the plurality of virtual driving route data by reflecting a characteristic of the unit vector configuring the actual driving route data in the corner section.

7. The apparatus of claim 6, wherein:
the virtual driving route data module generates the plurality of virtual driving route data by reflecting a characteristic of the unit vector configuring the actual driving route data in the straight section.

8. The apparatus of claim 7, wherein:
at least some of the plurality of generated virtual driving route data have a rounded shape in the corner section and a meandering shape in the straight section.

9. The apparatus of claim 1, wherein:
the second driving route module generates the second driving route in a grid form.

10. The apparatus of claim 1, wherein:
the parking position determining module sequentially connects the second driving route to a driving route according to the driving information of the vehicle at the time of arrival at the indoor parking lot to determine the final parking position of the vehicle.

11. A method of detecting a parking position of a vehicle, the method comprising:
generating, by a first driving route module, a first driving route of a vehicle based on driving information including a speed and a direction of the vehicle through an indoor parking lot;
generating, by a second driving route module, a second driving route by inputting the generated first driving route to an artificial intelligence model that corrects errors between the first driving route of the vehicle and an actual driving route of the indoor parking lot through machine learning; and
determining, by a parking position determining module, a final parking position of the vehicle in the indoor parking lot based on the generated second driving route.

12. The method of claim 11, wherein:
the generating of the first driving route includes generating the first driving route formed of a plurality of unit vectors that represents the driving information of the vehicle, respectively.

13. The method of claim 12, wherein:
the generating of the second driving route includes sequentially correcting an error in each of the plurality of unit vectors configuring the first driving route in a chronological order through the artificial intelligence model.

14. The method of claim 11, further comprising:
generating the artificial intelligence model,
wherein the generating of the artificial intelligence model includes:
receiving, by an actual driving route data receiving module, a plurality of actual driving route data collected from vehicles driving through an indoor parking lot;
generating, by a reference driving route data module, reference driving route data in which the driving route of the indoor parking lot is formed as a vector space in a shape of a polygon;
generating, by a virtual driving route data module, a plurality of virtual driving route data for each of the actual driving route data by reflecting characteristics of the actual driving route data in the reference driving route data; and
performing, by a machine learning module, machine learning to compare the actual driving route data and the virtual driving route data with the reference driving route data, and to extract and correct an error.

15. The method of claim 14, wherein:
the actual driving route data and the virtual driving route data are formed of a unit vector reflecting a driving speed and direction of the vehicle.

16. The method of claim 15, wherein:
the vector space in the shape of a polygon configuring the reference driving route data includes a straight section and a corner section, and
the generating of the virtual driving route data includes generating the plurality of virtual driving route data by reflecting a characteristic of the unit vector configuring the actual driving route data in the corner section.

17. The method of claim 16, wherein:
the generating of the virtual driving route data further includes generating the plurality of virtual driving route data by reflecting a characteristic of the unit vector configuring the actual driving route data in the straight section.

18. The method of claim 17, wherein:
at least some of the plurality of generated virtual driving route data have a rounded shape in the corner section and a meandering shape in the straight section.

19. The method of claim 11, wherein:
the generating of the second driving route includes generating the second driving route in a grid form.

20. The method of claim 11, wherein:
the determining of the final parking position of the vehicle includes sequentially connecting the second driving route to a driving route of the vehicle at the time of arrival at the indoor parking lot to determine the final parking position of the vehicle.
